(19) United States
(12) Patent Application Publication
(10) Pub. No.: US 2025/0328743 A1
(43) Pub. Date: Oct. 23, 2025

(54) Barcode Food Delivery Sealing System

(71) Applicant: Neil Tucker, Orlando, FL (US)

(72) Inventor: Neil Tucker, Orlando, FL (US)

(21) Appl. No.: 18/672,818

(22) Filed: May 23, 2024

Related U.S. Application Data
(60) Provisional application No. 63/635,841, filed on Apr. 18, 2024.

(51) Int. Cl. G06K 7/14; G06K 19/06; G06Q 50/12

(52) U.S. Cl. CPC G06K 7/1417; G06K 7/1413; G06K 19/06028; G06K 19/06037; G06Q 50/12

(57) ABSTRACT

A barcode food delivery sealing system is provided. The system is comprised of a sealable food receptacle equipped with an anti-tampering sticker containing at least one scannable code. The sticker is placed over the food receptacle after food has been placed into the food receptacle such that the sticker remains intact unless cut or removed by the end customer. The code interacts with a mobile application, enabling multiple users to track and verify the contents and authenticity of the food order during various stages of the delivery process. More specifically, the application allows restaurant workers and delivery drivers to scan the code, confirm the order's integrity, and upload relevant photos, wherein a customer can then ensure the delivered food matches the initial order placed and maintained throughout the delivery process.

### CROSS-REFERENCE TO RELATED APPLICATION

The present application claims priority to, and the benefit of, U.S. Provisional Application No. 63/635,841, which was filed on Apr. 18, 2024, and is incorporated herein by reference in its entirety.

### FIELD OF THE INVENTION

The present invention relates generally to the field of food delivery. More specifically, the present invention relates to a delivery food receptacle and/or barcode food delivery sealing system that can be applied to a food delivery food receptacle to ensure the correct food order is delivered in an untampered manner. Accordingly, the present disclosure makes specific reference thereto. Nonetheless, it is to be appreciated that aspects of the present invention are also equally applicable to other like applications, devices, and methods of manufacture.

### BACKGROUND

Having food delivered carries the potential risk of tampering by delivery personnel, highlighting significant concerns regarding the security and safety of the food items during transit. This issue not only raises questions about the integrity of the food delivery process but also underscores the need for safety measures to ensure that the food that reaches consumers remains uncontaminated and safe to consume.

Therefore, there exists a long-felt need in the art for a food delivery security device. There also exists a long-felt need in the art for a barcode food delivery sealing system. More specifically, there exists a long-felt need in the art for a barcode food delivery sealing system that provides a comprehensive system that ensures the correct food order is delivered to a customer, wherein the order is not tampered with during delivery.

The subject matter disclosed and claimed herein, in one embodiment thereof, comprises a barcode food delivery sealing system. The system is comprised of a sealable food receptacle equipped with an anti-tampering sticker containing at least one scannable code. The sticker is placed over the food receptacle after food has been placed into the food receptacle such that the sticker remains intact unless cut or removed by the end customer. The code interacts with a mobile application, enabling multiple users to track and verify the contents and authenticity of the food order during various stages of the delivery process. More specifically, the application allows restaurant workers and delivery drivers to scan the code, confirm the order's integrity, and upload relevant photos, wherein a customer can then ensure the delivered food matches the initial order placed and maintained throughout the delivery process.

In this manner, the barcode food delivery sealing system of the present invention accomplishes all the foregoing objectives and provides a food delivery security device. More specifically, the system ensures the correct food order is delivered to a customer. In addition, the system ensures the order is not tampered with during delivery.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a barcode food delivery sealing system. The system is comprised of a food receptacle for food deliveries, wherein the food receptacle can be sealed via at least one anti-tampering sticker. The sticker is comprised of at least one code that can be scanned to ensure a customer receives a correct food order.

Once food is placed inside the food receptacle prior to delivery, the sticker can be used to seal the food receptacle shut such that the food receptacle cannot be opened without removing/cutting the sticker. The top surface of the sticker is comprised of at least one scannable code that can be scanned by a smart device (such as a cell phone) that has a mobile application of the system installed.

As a result, the mobile application allows a first user, such as a restaurant worker, to verify the proper food has been placed into the food receptacle for delivery and also upload a photo of the food to the application. The code can then be scanned by a second user, such as a delivery driver, who can confirm the food receptacle delivered was the same food receptacle picked up from the restaurant, and wherein the second user can also upload a photo of the food receptacle (while sealed by the sticker) to the application. Once the food receptacle has been received by a third user (the customer), the customer can view the uploaded photos to ensure the code and sticker in the photos match the current code and sticker on the package they have been delivered.

The present invention is also comprised of a method of using the device. First, a system is provided comprised of a food receptacle comprised of at least one sticker comprised of at least one code, and a mobile application. Then, a food order can be placed into the food receptacle, wherein a first user (such as, but not limited to, a restaurant worker) can verify the correct order has been placed into the food receptacle via scanning the code and uploading a photo of the order to the mobile application. Then, the sticker can be applied over the food receptacle such that the food receptacle cannot be opened without removing/damaging the sticker. Next, the food receptacle can be picked up for delivery by a second user, wherein the user can scan the code to upload a photo of the food receptacle showing the sticker is unbroken and the sticker visible on the food receptacle is the correct sticker from the first photo taken by the first user. Next, the second user can deliver the food receptacle to a customer. Finally, the customer can view the application to view the photos taken by the first user and the second user to ensure the correct order was delivered in an untampered manner.

Accordingly, the barcode food delivery sealing system of the present invention is particularly advantageous as it provides a food delivery security device. More specifically, the system ensures the correct food order is delivered to a customer. In addition, the system ensures the order is not tampered with during delivery. In this manner, the barcode food delivery scaling system overcomes the limitations of existing food delivery methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a receptacle and a sticker of one potential embodiment of a barcode food delivery sealing system of the present invention in accordance with the disclosed architecture;

FIG. 2 illustrates a graphical view of features of a mobile application of one potential embodiment of a barcode food delivery sealing system of the present invention in accordance with the disclosed architecture; and

FIG. 3 illustrates a flowchart of a method of using one potential embodiment of a barcode food delivery sealing system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a food delivery security device. There also exists a long-felt need in the art for a barcode food delivery sealing system. More specifically, there exists a long-felt need in the art for a barcode food delivery sealing system that provides a comprehensive system that ensures the correct food order is delivered to a customer, wherein the order is not tampered with during delivery.

The present invention, in one exemplary embodiment, is comprised of a barcode food delivery sealing system. The system is comprised of a food receptacle for food deliveries. The food receptacle can be sealed via at least one anti-tampering sticker comprised of at least one code that can be scanned to ensure a customer receives a correct food order.

Once food is placed inside the food receptacle prior to delivery, the sticker can be used to seal the food receptacle shut such that the food receptacle cannot be opened without removing/cutting the sticker. The top surface of the sticker is comprised of at least one scannable code that can be scanned by a smart device (such as a cell phone) that has a mobile application of the system installed.

As a result, the mobile application allows a first user, such as a restaurant worker, to verify the proper food has been placed into the food receptacle for delivery and also upload a photo of the food to the application. The code can then be scanned by a second user, such as a delivery driver, who can confirm the food receptacle delivered was the same food receptacle picked up from the restaurant, and wherein the second user can also upload a photo of the food receptacle (while sealed by the sticker) to the application. Once the food receptacle has been received by a third user (the customer), the customer can view the uploaded photos to ensure the code and sticker in the photos match the current code and sticker on the package they have been delivered.

The present invention is also comprised of a method of using the device. First, a system is provided comprised of a food receptacle comprised of at least one sticker comprised of at least one code, and a mobile application. Then, a food order can be placed into the food receptacle, wherein a first user (such as, but not limited to, a restaurant worker) can verify the correct order has been placed into the food receptacle via scanning the code and uploading a photo of the order to the mobile application. Then, the sticker can be applied over the food receptacle such that the food receptacle cannot be opened without removing/damaging the sticker. Next, the food receptacle can be picked up for delivery by a second user, wherein the user can scan the code to upload a photo of the food receptacle showing the sticker is unbroken and the sticker visible on the food receptacle is the correct sticker from the first photo taken by the first user. Next, the second user can deliver the food receptacle to a customer. Finally, the customer can view the application to view the photos taken by the first user and the second user to ensure the correct order was delivered in an untampered manner.

Accordingly, the barcode food delivery sealing system of the present invention is particularly advantageous as it provides a food delivery security device. More specifically, the system ensures the correct food order is delivered to a customer. In addition, the system ensures the order is not tampered with during delivery. In this manner, the barcode food delivery sealing system overcomes the limitations of existing food delivery methods known in the art.

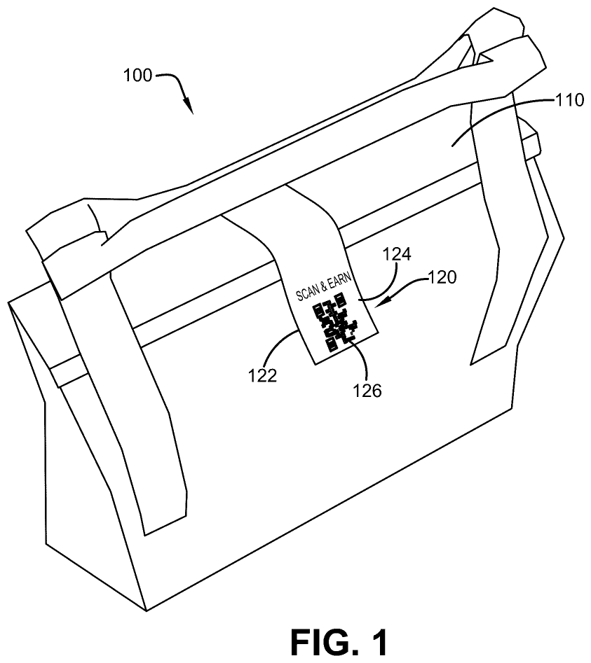

Referring initially to the drawings, FIG. 1 illustrates a perspective view of a receptacle 110 and a sticker 120 of one potential embodiment of a barcode food delivery sealing system of the present invention in accordance with the disclosed architecture. The device 100 is comprised of a food receptacle 110 for food deliveries, wherein the food receptacle 110 can be sealed via at least one anti-tampering sticker 120. The sticker 120 is comprised of at least one code 126 that can be scanned to ensure a customer receives a correct food order.

The food receptacle 110 may be any food delivery food receptacle 110 (or other food receptacle type) known in the art in any configuration. This includes, but is not limited to, bags, containers, jars, boxes, etc., of any material such as, but not limited to, paper, plastic, Styrofoam, etc. The food receptacle 110 may be any size to accommodate any amount of food.

Once food is placed inside the food receptacle 110 prior to delivery, at least one sticker 120 can be used to seal the food receptacle 110 shut such that the food receptacle 110 cannot be opened without removing/cutting the sticker. The sticker 120 is comprised of an adhesive bottom surface 122 that adheres to the food receptacle 110. The top surface 124 of the sticker 120 is comprised of at least one scannable code 126. The code 126 may include, but is not limited to, a barcode, a QR code, etc.

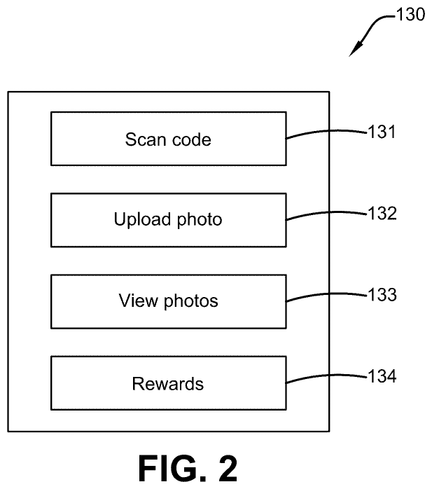

The code 126 can be scanned by a smart device (such as a cell phone) that has a mobile application 130 of the system installed, wherein features of the mobile application 130 can be seen in FIG. 2. As a result, the mobile application 130 allows a first user, such as a restaurant worker to verify the proper food has been placed into the food receptacle 110 for delivery and also allows the user to upload a photo 132 of the food to the application 130 by first scanning 131 the code 126. The code 126 can then be scanned 131 by a second user, such as a delivery driver, who can confirm the food receptacle 110 delivered was the same food receptacle 110 picked up from the restaurant, and wherein the second user can upload a photo 132 of the food receptacle 110 (while sealed by the sticker 120) to the application 130 after scanning the code 126. Once the food receptacle 110 has been received by a third user (the customer), the customer can view the uploaded photos 133 to ensure the code 126 and sticker 120 in the photos match the current code 126 and sticker 120 on the package they have been delivered.

The mobile application 130 may also offer a user rewards 134. The rewards 134 may include, but are not limited to, food discounts, delivery discounts, etc.

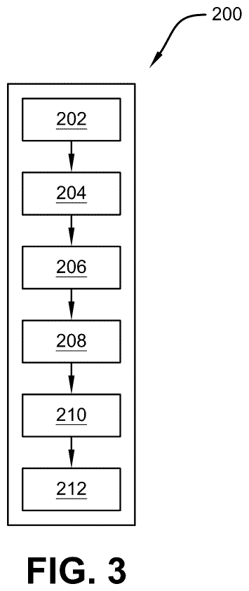

The present invention is also comprised of a method of using 200 the device 100, as seen in FIG. 3. First, a system 100 is provided comprised of a food receptacle 112, at least one sticker 120 comprised of at least one code 126, and a mobile application 130 [Step 202]. Then, a food order can be placed into the food receptacle 110, wherein a first user (such as, but not limited to, a restaurant worker) can verify the correct order has been placed into the food receptacle via scanning 131 the code 126 with a smart device and then uploading 132 a photo of the order to the mobile application [Step 204]. Then, the sticker 120 can be applied over the food receptacle 110 such that the food receptacle 110 cannot be opened without removing/damaging the sticker 120 [Step 206]. Next, the food receptacle 110 can be picked up for delivery by a second user, wherein the user can scan 131 the code 126 via a smart device to upload a photo 132 of the food receptacle 110 showing the sticker 120 is unbroken and the sticker 120 visible on the food receptacle 110 is the same sticker 120 from the first photo taken by the first user [Step 208]. Next, the second user can deliver the food receptacle 110 to a customer [Step 210]. Finally, the customer can view the application 130 to view the photos taken by the first user and the second user to ensure the correct order was delivered in an untampered manner [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “barcode food delivery sealing system” and “system” are interchangeable and refer to the barcode food delivery sealing system 100 of the present invention.

Notwithstanding the foregoing, the barcode food delivery sealing system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the barcode food delivery sealing system 100 as shown in the FIGS. are for illustrative purposes only, and that many other sizes and shapes of the barcode food delivery sealing system 100 are well within the scope of the present disclosure. Although the dimensions of the barcode food delivery sealing system 100 are important design parameters for user convenience, the barcode food delivery sealing system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A barcode food delivery sealing system comprising:
a food receptacle;
a sticker comprised of a code; and
a mobile application comprising a user reward component.

2. The barcode food delivery sealing system of claim 1, wherein the sticker is comprised of an adhesive bottom surface.

3. The barcode food delivery sealing system of claim 1, wherein the food receptacle is comprised of a bag or a food receptacle.

4. The barcode food delivery sealing system of claim 1, wherein the food receptacle is comprised of a paper, a plastic, or a Styrofoam material.

5. The barcode food delivery sealing system of claim 1, wherein the code is comprised of a barcode or a QR code.

6. The barcode food delivery sealing system of claim 1, wherein the code can be scanned by the mobile application.

7. The barcode food delivery sealing system of claim 6, wherein scanning the code allows a photo to be uploaded to the mobile application.

8. A barcode food delivery sealing system comprising:
a food receptacle comprising a jar;
a sticker comprised of a scannable code positioned on a top surface of the sticker; and
a mobile application comprising a user reward component comprising a food discount reward.

9. The barcode food delivery sealing system of claim 8, wherein the sticker is comprised of an adhesive bottom surface.

10. (canceled)

11. (canceled)

12. The barcode food delivery sealing system of claim 8, wherein the scannable code is comprised of a barcode or a QR code.

13. The barcode food delivery sealing system of claim 8, wherein the code can be scanned by the mobile application.

14. The barcode food delivery sealing system of claim 8, wherein the code can be scanned by the mobile application.

15. The barcode food delivery sealing system of claim 14, wherein scanning the code allows a photo to be uploaded to the mobile application.

16. A method of using a barcode food delivery sealing system, the method comprising the following steps:
providing a barcode food delivery sealing system comprised of a food receptacle, a sticker comprised of a code, and a mobile application;
placing a food order into the food receptacle and sealing the food receptacle by placing the sticker onto the food receptacle;
scanning the code via a first smart device;
taking a first photo of the food order and uploading the first photo to the mobile application;
picking up the food receptacle for delivery;
scanning the code via a second smart device;
taking a second photo of the food receptacle and uploading the second photo to the mobile application; and
viewing the mobile application to view the first photo and the second photo to confirm the food receptacle delivered is the food receptacle in the first photo and in the second photo; and
wherein the mobile application comprises a user reward component comprising a food discount reward and a delivery discount reward.

17. The method of using a barcode food delivery sealing system of claim 16, wherein the code is comprised of a barcode or a QR code.

18. The method of using a barcode food delivery sealing system of claim 16, wherein the food receptacle is comprised of a container or a bag.

19. The method of using a barcode food delivery sealing system of claim 16, wherein the sticker is comprised of an adhesive bottom surface.

20. The method of using a barcode food delivery sealing system of claim 18, wherein the container is comprised of a paper, a plastic, or a Styrofoam material.
